(19) United States
(12) Patent Application Publication
(10) Pub. No.: US 2010/0001197 A1
(43) Pub. Date: Jan. 7, 2010

(54) Radiation imaging apparatus

(75) Inventor: Tatsuya Aoyama, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/458,179

(22) Filed: Jul. 2, 2009

(30) Foreign Application Priority Data
Jul. 3, 2008 (JP) 2008-174628

(51) Int. Cl. G01T 1/24

(52) U.S. Cl. 250/370.09

(57) ABSTRACT

A radiation imaging apparatus includes a radiation source; a radiation conversion panel for outputting a radiation image corresponding to radiation received from the radiation source; an image processing section for performing image processing on the radiation images supplied from the radiation conversion panel; a radiation focused grid arranged to cover a radiation receiving surface of the radiation conversion panel; a moving mechanism for moving the grid; and a switching mechanism for setting the moving mechanism a first mode for imaging as the grid moves unidirectionally for each of the radiation images or a second mode for imaging as the grid moves in an opposite direction to the unidirectional direction for each of the radiation image, when taking the radiation images.

### BACKGROUND OF THE INVENTION

The present invention relates to a radiation imaging apparatus for generating radiation images by taking a plurality of radiation images from an object irradiated by radiation having different energy characteristics, and performing energy subtraction processing using the plurality of taken radiation images.

### RELATED ART

Radiation imaging apparatuses are used in various fields, including, for example, medical diagnostic imaging and industrial non-destructive inspection testing, and the like. Radiation imaging apparatuses irradiate an object (subject) with radiation (x-rays, alpha rays, beta rays, gamma rays, electrons, ultraviolet rays and the like) from a radiation source, detect the rays which are transmitted through the object using a radiation conversion panel, and generate a radiation image of the object by converting the radiation to electrical signals and rendering a visible image.

The radiation conversion panel converts the irradiating radiation to electrical signals. Known types of radiation conversion panels include storage phosphor sheets which accumulate radiation energy and emit photostimulated luminescence light corresponding to the radiation energy via irradiation by excitation light, and flat-panel type radiation detectors (FPDs) which directly convert the received radiation to electrical signals that correspond to the amount of radiation.

JP 03-132749 A discloses multi-energy technology, such as energy subtraction and the like, which takes two or more radiation images by irradiating an object with radiation having different energy characteristics, and emphasizes or eliminates desired tissue by performing mathematical operations using the taken radiation images.

In imaging apparatuses using storage phosphor sheets, a filter such as a copper sheet is inserted between two storage phosphor sheets, and two radiation images having respectively different energies are obtained by the two storage phosphor sheets via a single imaging. In imaging apparatuses using FPD, however, a radiation images having different energies can be obtained by two consecutive imagings in which the second imaging is performed after changing the tube voltage of the radiation source in a short time.

Imaging apparatuses using FPD can obtain images which have excellent energy separation compared to imaging apparatuses that use storage phosphor sheets which change the energy characteristic by using a filter because the energy characteristics can be changed by imaging at different tube voltages. However, when the energy subtraction process is performed in the imaging apparatus using FPD, a problem arises in that the influence of motion artifacts increases due to the respiration and heart beat functions of the patient between imagings since a plurality of imaging are performed.

In contrast, JP 2002-243860 A (U.S. Pat. No. 6,343,112 B1), JP 2004-261489 A, and JP 2002-325756 A (U.S. Pat. No. 6,643,536 B2) pertain to conventional art. JP 2002-243860 A (U.S. Pat. No. 6,343,112 B1) discloses reducing the imaging interval to the second imaging by reducing the amount of x-ray during the first imaging. JP 2004-261489 A discloses reducing the imaging time to the second imaging by reading the x-ray image taken in the first imaging at high speed in a low resolution mode. JP 2002-325756 A (U.S. Pat. No. 6,643,536 B2) discloses performing imaging coordinated with the heart beat of the patient.

JP 2002-243860 A (U.S. Pat. No. 6,343,112 B1) and JP 2004-261489 A suppress the influence of motion artifacts by reducing the imaging interval by means of improvement of methods of reading radiation image data. JP 2002-325756 A (U.S. Pat. No. 6,643,536 B2), on the other hand, reduces the influence of motion artifacts by means of improvement of the timing of the imaging.

In radiation imaging apparatuses a radiation focused grid (scattered radiation eliminator) is disposed parallel to the radiation-receiving surface of the radiation conversion panel so that the radiation-receiving surface of the radiation conversion panel is covered with a predetermined spacing from the radiation-receiving surface of the radiation conversion panel. This grid is constructed to house the grid body, which is configured by a plurality of plates arranged at a predetermined spacing in a one-dimensional (unidirectional) lattice (grid), on the inner side of a rectangular frame.

A problem arises in that the shadow of the grid (plate) appears as moire on the radiation image when the grid is stopped and the image is taken. This problem is particularly remarkable in imaging apparatuses using FPD due to the high definition of the taken radiation image. Imaging is therefore performed as the grid is moving in imaging apparatuses to avoid moire generation caused by the grid. This grid movement control is referred to as bucky control.

Even in imaging apparatuses using multi energy technology, it is desirable to perform imaging as the grid is moving to avoid moire generation caused by the grid. Since the radiation image taken using FPD has particularly high definition, there is some residual moire due to the timing of the imaging (when the grid stops at the end of the movement and the like) by the bucky control in a simple reciprocating movement. Normally, therefore, bucky control is used to perform the imaging as the grid moves unidirectionally.

In imaging apparatuses using multi energy technology, there are cases in which the imaging interval can be shortened as in the methods employed in JP 2002-243860 A (U.S. Pat. No. 6,343,112 B1) and JP 2004-261489 A, and cases in which the imaging interval is lengthened at imaging parts other than the thoracic area or by means of improvement of the method in JP 2002-325756 A (U.S. Pat. No. 6,643,536 B2).

Furthermore, when imaging is performed twice in succession using multi energy technology by changing the tube voltage and imaging in a short time, it is difficult to reduce the tube voltage to a desired tube voltage for the second imaging due to the influence of the wave tail of the x-ray tube voltage when imagings are performed from a high tube voltage to a low tube voltage. Imagings are therefore normally performed from a low tube voltage to a high tube voltage. Since the tube voltage is a high tube voltage of approximately 120 kV in the thoracic region imaging, the first imaging of the thoracic area is considered a non-diagnostic image and the second imaging is considered a diagnostic image. However, a diagnostic image may also be taken by the first imaging when imaging is performed by changing the tube voltage using multi energy technology since the tube voltage of the radiation source is changed when taking a diagnostic image according to the area being imaged (chest, 120 kV; spine, 80 kV; limbs, 50 kV; and the like).

### SUMMARY OF THE INVENTION

An object of the present invention is to provide a radiation imaging apparatus capable of producing high quality radiation images by preventing the generation of moire caused by the grid which is not limited to energy subtraction images.

### BRIEF DESCRIPTION OF THE DRAWINGS

FIG. 1 is a block diagram of the embodiment showing the structure of the radiation imaging apparatus of the present invention;

FIG. 2 is a conceptual diagram showing the positional relationship of the radiation source, grid, and FPD;

FIGS. 3A and 3B are respectively graphs showing a first example of bucky control;

FIGS. 4A and 4B are respectively graphs showing a second example of bucky control;

FIG. 5 is a graph showing a third example of bucky control; and

FIGS. 6A through 6C are respectively conceptual diagrams showing the relationship between the grid position and the radiation dose.

### DETAILED DESCRIPTION OF THE INVENTION

The radiation imaging apparatus of the present invention is described in detail hereinafter based on the preferred embodiment shown in the accompanying drawings.

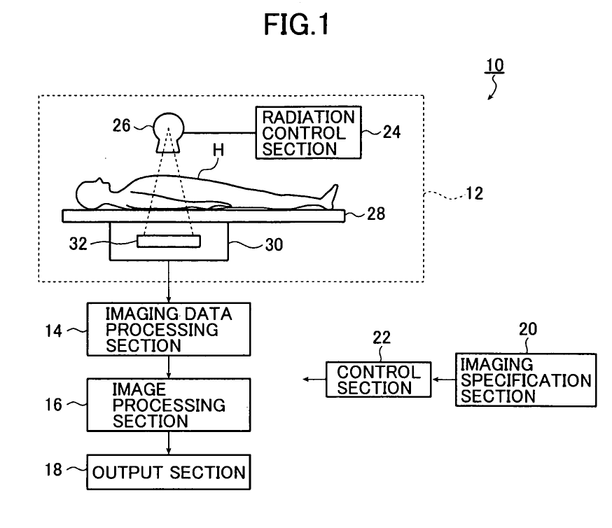

FIG. 1 is a block diagram of the embodiment showing the structure of the radiation imaging apparatus of the present invention. A radiation imaging apparatus 10 shown in this drawing irradiates an object with radiation having different energy characteristics (energy levels) and takes a plurality (for example, two) of radiation images, then generates a radiation image by performing an energy subtraction process using the taken plurality of radiation images. The imaging apparatus 10 is configured by an imaging section 12, imaging data processing section 14, image processing section 16, output section 18, imaging instruction section 20, and control section 22.

The imaging section 12 is a portion for imaging the object (subject) H by irradiating the object H with radiation and detecting the radiation which passes through the object H. The taken radiation image data (analog data) are output from the imaging section 12. Details of the imaging section 12 are described later.

The imaging data processing section 14 is a portion for performing data processing such as A/D (analog/digital) conversion and the like on the radiation image data supplied from the imaging section 12. After data processing, the radiation image data (digital data) are output from the imaging data processing section 14.

The image processing section 16 is a portion for generating a processed radiation image by performing image processing such as offset correction, after image correction, energy subtraction processing and the like on the radiation image which has already been subjected to data processing and supplied from the imaging data processing section 14. The image processing section 16 is configured by a program (software) working on a computer, dedicated hardware, or a combination of both. After image processing, the radiation image data are output from the image processing section 16.

The output section 18 is a portion for outputting the image-processed radiation image data supplied from the image processing section 16. The output section 18, for example, can be a monitor for displaying the radiation image on a screen, a printer for printing the radiation image, a memory device for storing radiation image data and the like.

The imaging instruction section 20 is a portion for setting the imaging conditions and imaging modes, and for giving an instruction of imaging of the object H. Input keys for setting the imaging conditions and imaging modes, imaging buttons for giving the instructions of imaging and the like can be used as the imaging instruction section 20.

The control section 22 is a portion for controlling the operation of each section of the imaging apparatus 10 in accordance with the information of the imaging conditions and imaging modes, imaging instruction signals for giving an instruction of imaging, switching instruction signals for switching the grid movement method and the like supplied from the imaging instruction section 20.

The imaging apparatus 10 is provided with, as imaging modes, a plurality of types of automatic imaging modes (imaging menus) for pre-setting the imaging conditions, such as intensity of the radiation, irradiation time (radiation level) and the like, in addition to a manual imaging mode for manually setting imaging conditions such as the intensity of the radiation, irradiation time and the like. It is desirable that the automatic imaging modes are capable of recording (storing) user defined (set) imaging conditions.

The imaging section 12 is further discussed below.

As shown in FIG. 1, the imaging section 12 is configured by an irradiation control unit 24, radiation source 26, imaging platform 28, and radiation detection unit 30.

The irradiation control unit 24 actuates the radiation source 26 and controls the irradiation level so that radiation at the intensity set according to the imaging conditions and imaging mode irradiates for only the set time. The radiation emitted from the radiation source 26 irradiates the object H on the imaging platform 28. The radiation detection unit 30 receives the radiation which has passed through the object H, converts the radiation to electrical signals corresponding to the received radiation, and outputs radiation image data (analog data) (radiation image).

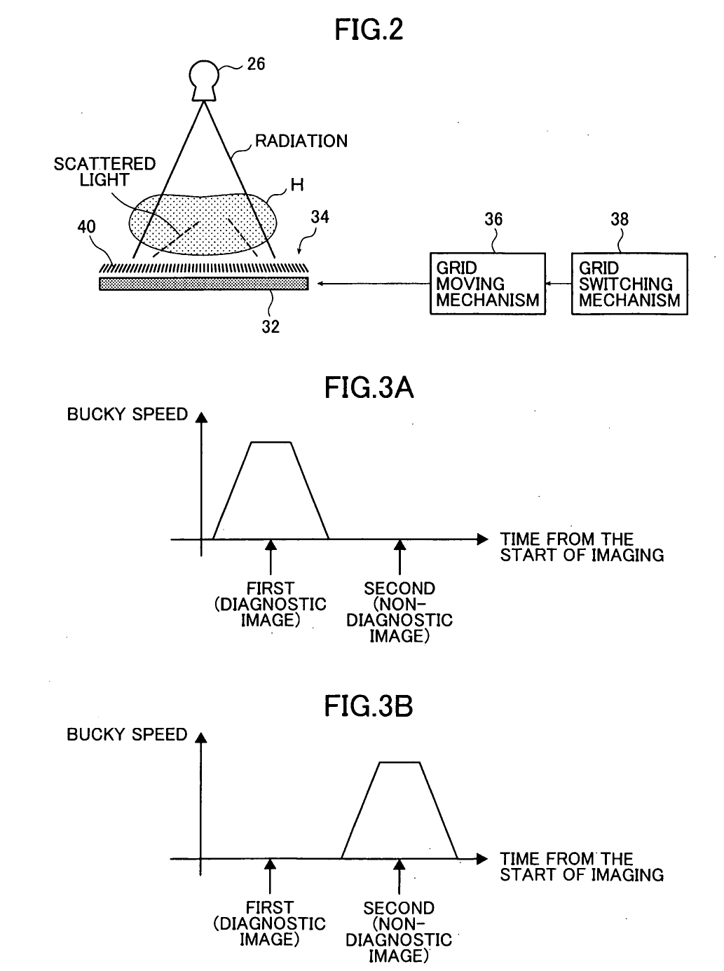

As shown in FIG. 2, the radiation detection unit 30 is configured by an FPD 32, radiation focused grid (for eliminating scattered radiation) 34, grid moving mechanism 36, and grid switching mechanism 38.

As previously mentioned, the grid 34 is configured by a plurality of plates 40 arranged at a predetermined spacing in a unidirectional (a direction perpendicular to the paper surface in FIG. 1; a lateral direction in FIG. 2) lattice (grid), as shown in FIG. 2. Each plate 40 is inclined at an angle conforming to the radiation direction of the radiation when the grid 34 is stopped so that the center positions of the grid 34 and the FPD 32 match.

The grid 34 is arranged parallel to the radiation-receiving surface of the FPD 32 so as to cover the radiation-receiving surface of the FPD 32 at a predetermined spacing from the radiation-receiving surface of the FPD 32. The positional relationships of the radiation source 26, grid 34 and FPD 32 are as shown in FIG. 2, and the grid 34 disposed between the radiation source 26 and the FPD 32. The radiation emitted from the radiation source 26 is linearly projected through the grid 34 toward the position of the pixels 33 of the radiation-receiving surface of the FPD 32.

The switching mechanism 38 switches the setting of the moving mechanism 36 to a first mode for moving the grid 34 in one direction [the disposition direction of the plates 40 (a direction perpendicular to the paper surface in FIG. 1; a lateral direction in FIG. 2)] (imaging while moving in one direction) and setting of the moving mechanism 36 to a second mode for moving the grid 34 one by one at a time in a reciprocating movement (imaging one in the outward path and imaging another in return path while moving reciprocatingly) when taking each of a plurality of radiation images for performing energy subtraction processing. Furthermore, the switching mechanism 38 switches the setting of the moving mechanism 36 to change the moving speed of the grid 34 relative to the respective plurality of images.

The switching of the moving method of the grid 34, for example, can be automatically determined according to the imaging condition and imaging mode, and imaging part, and can be directly specified by the user from the imaging instruction section 20. In the case of the automatic imaging mode (imaging menu), it is desirable that the imaging condition can be freely determined by the user, and that this setting can be recorded (stored) as a user defined automatic imaging mode.

An example of imaging as the grid 34 is moving unidirectionally is thoracic imaging, and examples of imaging as the grid 34 is moving reciprocatingly are spinal imaging, pyramidal imaging, and imaging of thick parts such as thoracic imaging synchronously with the heart beat.

The moving mechanism 36 is set to the first mode for moving the grid 34 in one direction (outward direction or return direction) along the disposition of the plates 40 (imaging as the grid 34 is moving in the same direction relative to a plurality of taken images), or set to a second mode for reciprocating movement (imaging as the grid 34 is moved in opposite directions for each imaging) according to the switching signal from the switching mechanism 38. The moving mechanism 36 moves the grid 34 in a predetermined direction along the radiation receiving surface of the FPD 32. Similarly, the moving mechanism 36 also changes the moving speed [including when stopping the grid 34 (moving speed zero)] of the grid 34 according to the switching signals from the switching mechanism 38 when imaging a plurality of radiation images for performing energy subtraction processing.

Although not shown in the drawings, the radiation source 26 and radiation detection unit 30 are configured to be capable of reciprocal movement along the longitudinal direction (lateral direction in FIG. 1) of the imaging platform 28, for example, in the case of long imaging. Alternatively, the imaging platform 28 can also be configured to be capable of movement.

The operation of the imaging apparatus 10 is described below.

When the imaging button of the imaging instruction section 20 is pressed, imaging starts via the control of the control section 22. In the imaging section 12, radiation is emitted from the radiation source 26 at the intensity set corresponding to the imaging conditions and imaging mode for the set time only. The emitted radiation passes through the object H on the imaging platform 28 and enters the FPD 32 through the grid 34 of the radiation detection unit 30, and the radiation which has passed through the object H is converted to electrical signals (radiation image data).

When imaging each of a plurality of radiation images for performing energy subtraction processing, the gird 34 is switched to move unidirectionally or move reciprocatingly by the switching mechanism 38. In accordance therewith, the grid 34 is moved in one direction (outward path direction or return path direction) or moves reciprocatingly along the direction of the disposition of the plates 40 by the moving mechanism 36.

Then, the taken radiation image data are read from the FPD 32, subjected to A/D conversion processing and the like by the imaging data processing section 14, and supplied to the image processing section 16. The image processing section 16 performs image processing such as offset correction, after image correction, and energy subtraction processing and the like on the radiation image data supplied from the imaging data processing section 14. After image processing, the radiation image data (radiation image) are supplied to the output section 18.

The output section 18, for example, displays the radiation image corresponding to the radiation image data on a monitor, prints the radiation image from a printer, or stores the radiation image data in a memory device.

The bucky control of the imaging apparatus 10 is described below.

A plurality of radiation images are used in the energy subtraction process. In the imaging apparatus 10, for example, imaging is performed consecutively twice by changing the radiation energy level (energy characteristics) when performing energy subtraction processing using two radiation images. At this time, the first imaging is performed by imaging a diagnostic image for use in diagnosis and the second imaging is performed by imaging a non-diagnostic image which is not to be used for diagnosis, or, conversely, the first imaging is performed by imaging a non-diagnostic image which is not to be used in diagnosis and the second imaging is performed by imaging a diagnostic image for use in diagnosis.

FIGS. 3A and 3B respectively show examples in which one imaging is performed as the grid 34 is moved unidirectionally (outward path direction or return path direction), and another imaging is performed with the grid 34 stopped when consecutively performing a first and second imaging.

FIG. 3A is a graph showing the bucky control when the first imaging is for a diagnostic image and the second imaging is for a non-diagnostic image. The vertical axis of this graph represents the bucky speed, and the horizontal axis represents the elapsed time from the start of imaging (this arrangement is the same for subsequent graphs). The first imaging is performed as the grid 34 is moved at a predetermined speed when imaging the diagnostic image, and the second imaging is performed with the grid 34 stopped (moving speed zero) when imaging the non-diagnostic image.

FIG. 3B, on the other hand, is a graph showing the bucky control when the first imaging is for a non-diagnostic image and the second imaging is for a diagnostic image. In this case, the bucky control is the opposite of that shown in the graph of FIG. 3A. That is, the first imaging is performed with the grid 34 stopped when imaging the non-diagnostic image, and the second imaging is performed as the grid 34 is moved at a predetermined speed when imaging the diagnostic image.

In the examples of FIGS. 3A and 3B, the diagnostic image is taken as the grid 34 is moving, and the non-diagnostic image is taken while the grid 34 is stopped. In this case, insofar as the FPD 32 is a high-performance device, there is a high possibility of some residual moire of the grid 34 appearing in the taken non-diagnostic image.

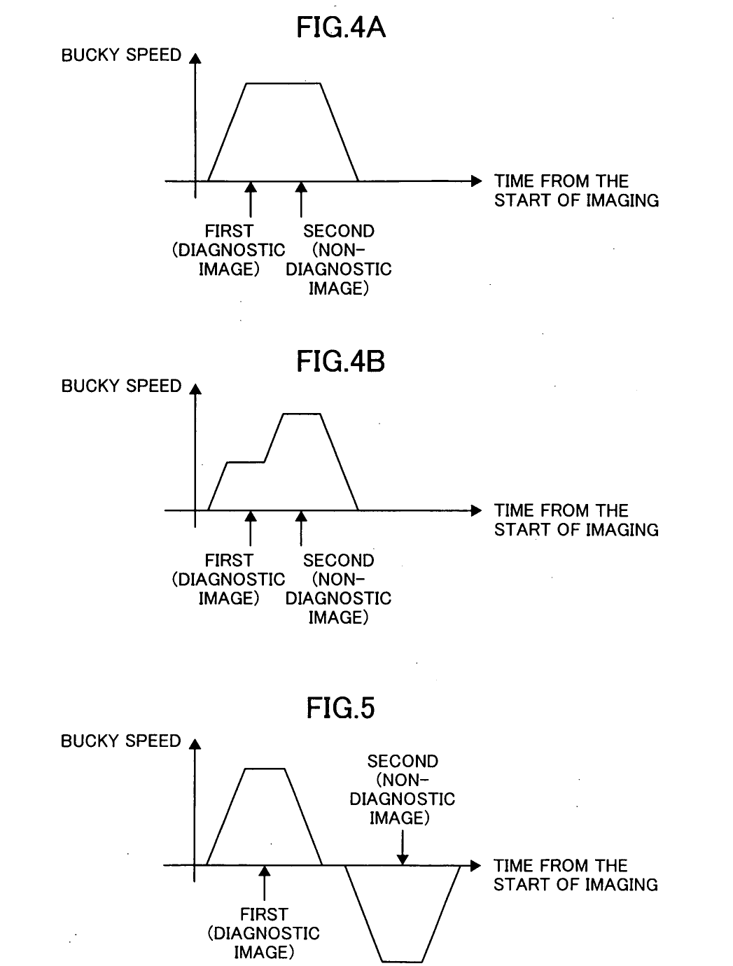

FIGS. 4A and 4B respectively show examples of performing two consecutive imagings as the grid 34 is moving unidirectionally.

FIG. 4A shows the first imaging performed for the non-diagnostic image as the grid 34 is moving unidirectionally at a predetermined speed, then the second imaging is performed for the diagnostic image.

Similar to FIG. 4A, FIG. 4B shows performing the imaging two times as the grid 34 is moving unidirectionally; however, the grid 34 moves at low speed when performing the first imaging for the first non-diagnostic image, and the grid 34 moves at high speed when performing the second imaging for the diagnostic image. The meanings of the low speed and the high speed refer to the speeds when comparing the moving speed of the grid 34 during the first imaging and the second imaging. The low speed means moving without stopping, and the high speed means moving at a speed higher than the low speed.

Note that the first imaging can also be performed for the diagnostic image, and the second imaging can be performed for the non-diagnostic image. In this case, the diagnostic image is also taken as the grid 34 moves at the high speed, and the non-diagnostic image is taken as the grid 34 moves at the low speed.

The movable distance of the grid 34 tends to gradually become shorter in conjunction with advances in making imaging apparatuses more compact. Therefore, when imaging is performed as the grid 34 moves unidirectionally, it becomes necessary to reduce the moving speed of the grid 34 according to the time required to perform the imaging two times. Conversely, a high quality diagnostic image (energy subtraction image) can be obtained without changing the moving distance of the grid 34 by changing the moving speed of the grid 34 when performing the first and second imagings.

The moving speed of the grid 34 is desirably such that the speed when taking the diagnostic image is faster than the speed when taking the non-diagnostic image. This arrangement can improve image quality of the diagnostic image to be used for diagnosis as well as an energy subtraction image.

Note that in the examples shown in FIGS. 3A and 3B, and FIGS. 4A and 4B, after the first radiation image has been taken as the grid 34 moves unidirectionally (outward path direction or return path direction), the second radiation image can also be taken as the grid 34 moves unidirectionally in the opposite direction (return path direction or outward path direction).

FIG. 5 shows an example of imaging as the grid 34 moves unidirectionally (outward path direction or return path direction) on one hand, and imaging as the grid 34 moves in the opposite direction (return path direction or outward path direction) on the other hand when consecutively imaging twice as the grid 34 moves.

In FIG. 5, the first imaging for the diagnostic image is performed as the grid 34 moves unidirectionally at a predetermined speed, and the second imaging for the non-diagnostic image is performed as the grid 34 moves at the same speed in the opposite direction.

Note that the non-diagnostic image can also be taken in the first imaging and the diagnostic image taken in the second imaging. In the example shown in FIG. 5, the moving speed of the grid 34 can also be changed when taking the first and second radiation images.

In the imaging apparatus 10, the switching mechanism 38 switches to move the grid 34 unidirectionally or reciprocatingly. For example, the grid 34 is moved unidirectionally when the imaging interval is short, and is moved reciprocatingly when the imaging interval is long. With this arrangement, a high quality radiation image (energy reduction image) can be obtained by suitably switching the moving method of the grid 34 according to the part to be taken.

Note that when the imaging interval is short, for example, is in such a case when taking two radiation images for energy subtraction processing, the imaging of two radiation images can be performed relative to the moving speed and moving distance (that is the moving time) of the grid 34. When the imaging interval is long, on the other hand, the expression is relative to the short image interval, and two radiation images cannot be taken in the moving time of the grid 34.

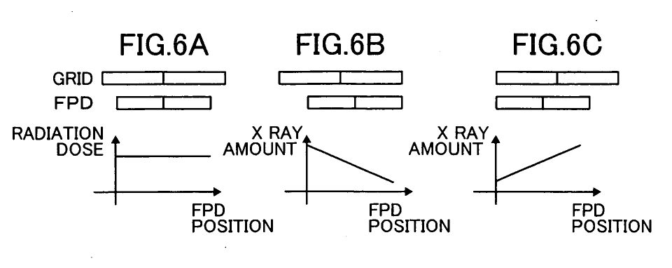

As shown in FIGS. 6A through 6C, in the focused grid 34, the density characteristics within the surface of the FPD 32 can change according to the pixel position by the positional relationship of the grid 34 and the FPD 32 during imaging.

FIG. 6A shows the state when the center positions of the grid 34 and the FPD 32 match. In this state, the radiation dose within the surface of the FPD 32 is fixed, and the density characteristics are uniform within the surface of the FPD 32. FIG. 6B shows the state in which the grid 34 is moving to the left side of the FPD 32, and FIG. 6C shows the state in which the grid 34 is moving to the right side of the FPD 32. In these states, the radiation dose is high on the side of the moving direction of the grid 34, and the density characteristics within the surface of the FPD 32 change according to the pixel position.

In the focused grid 34, the density characteristics within the surface of the FPD 32 change according to the pixel position when the grid 34 is positioned as shown in FIG. 6B or 6C. Density irregularity occurs when imaging is performed at the grid position shown in FIG. 6B or 6C and two radiation images are differentiated by energy subtraction processing (although this does not occur in normal taken images, density irregularity does occur when increasing the tone in differentiation.

Therefore, it is desirable to perform controls so as not to obtain the positional relationship shown in FIG. 6B or 6C by reducing the moving speed of the grid 34 when taking a non-diagnostic image as in the bucky control shown in FIG. 4B. In the example shown in FIG. 5, it is desirable to perform the imaging with a timing at which the positional relationship of the FPD 32 and grid 34 are mutually the same when taking the first and second radiation images, and further desirable to perform the imaging with a timing at which the center position of the FPD 32 becomes the symmetrical center position (the grid 34 is shifted the same amount from the center).

With this arrangement, it is possible to suppress the density irregularity generated by the positional relationship of the grid 34 and FPD 32 during imaging by balancing the density irregularity caused by the energy subtraction process with the moire caused by the grid 34.

Note that although the radiation conversion panel has been described by way of an example of an imaging apparatus using FPD, the present invention is also applicable to imaging apparatuses which use storage phosphor sheets. The structure of the imaging apparatus should be suitably determined according to the radiation conversion panel to be used. Furthermore, three or more radiation images can also be used for energy subtraction processing. In this case, a single radiation image is a diagnostic image and the remaining radiation images are non-diagnostic images.

Although energy subtraction has been described as an example in the above embodiment, several tens of images can be taken in a fixed interval by the FPD to obtain a series of radiation images like a movie. Such a series of images are used mainly to view the operation of joints and the like. When viewing a series of images such as this, an awareness of moire and irregularities is to be expected. In such imaging, when the imaging interval is short, imaging is performed a plurality of times while the bucky movement is unidirectional, and when the imaging interval is long, imaging is performed once while the bucky movement is unidirectional, the switching controls are performed to change the direction of the bucky movement for one imaging (each imaging) at the same grid position to suppress moire and obtain an irregularity free image. The above operation can be repeated when consecutively taking a plurality of radiation images.

Although the above embodiment has been described in detail, the present invention is not limited to the above embodiment and can of course be variously modified and improved insofar as such modifications and improvement remains within the scope of the claims.

What is claimed is:

1. A radiation imaging apparatus for irradiating an object with radiation, taking a plurality of radiation images, and generating a processed radiation image from said plurality of taken radiation images subjected to processing, comprising:
a radiation source for emitting radiation;
a radiation conversion panel for receiving the radiation emitted from said radiation source, and outputting a radiation image corresponding to said received radiation;
an image processing section for generating a processed radiation image by performing image processing on a plurality of radiation images supplied from said radiation conversion panel;
a radiation focused grid arranged to cover a radiation receiving surface of said radiation conversion panel;
a moving mechanism for moving said grid in a predetermined direction along said radiation receiving surface of said radiation conversion panel; and
a switching mechanism for setting said moving mechanism in either a first mode for imaging as said grid moves in a first direction for each of said plurality of radiation images or a second mode for imaging as said grid moves in an opposite direction to said first direction for each of said plurality of radiation image, when taking a plurality of radiation images.

2. The radiation imaging apparatus according to claim 1, wherein:
said moving mechanism is set in the second mode by said switching mechanism; and
said moving mechanism repeatedly moves said grid in the first direction when imaging a first radiation image, and moves said grid in the opposite direction to said first direction when imaging a second radiation image.

3. The radiation imaging apparatus according to claim 2, wherein:
said moving mechanism moves said grid in the first direction at a first speed when imaging said first radiation image; and
said moving mechanism moves said grid at a second speed which is different than said first speed in the opposite direction to said first direction when imaging said second radiation image.

4. The radiation imaging apparatus according to claim 3, wherein said second speed is faster than said first speed.

5. The radiation imaging apparatus according to claim 3, wherein said second speed is slower than said first speed.

6. The radiation imaging apparatus according to claim 2, wherein imagings are respectively performed with a timing in which the positional relationship between said grid and said radiation conversion panel is a same when taking a plurality of radiation images.

7. The radiation imaging apparatus according to claim 6, wherein imagings are respectively performed with a timing in which a center position of said grid and a center position of said radiation conversion panel match when taking said plurality of radiation images.

8. The radiation imaging apparatus according to claim 6, wherein imagings are respectively performed with a timing in which an amount of shift of said grid from a center position of said radiation conversion panel is a same when taking said plurality of radiation images.

9. A radiation imaging apparatus for irradiating an object with radiation having different energy characteristics, taking a plurality of radiation images, and generating a processed radiation image subjected to energy subtraction processing from said plurality of taken radiation images, comprising:
a radiation source for emitting radiation;
a radiation conversion panel for receiving the radiation emitted from said radiation source, and outputting a radiation image corresponding to said received radiation;
an image processing section for generating a radiation image subjected to energy subtraction processing using a plurality of radiation images supplied from said radiation conversion panel;
a radiation focused grid arranged to cover a radiation receiving surface of said radiation conversion panel;
a moving mechanism for moving said grid in a predetermined direction along said radiation receiving surface of said radiation conversion panel; and
a switching mechanism for setting said moving mechanism in either a first mode for imaging as said grid moves in a first direction for each of said plurality of radiation images or a second mode for imaging as said grid moves in an opposite direction to said first direction for each of said plurality of radiation image, when taking each of a plurality of radiation images for energy subtraction processing.

10. The radiation imaging apparatus according to claim 9,
wherein:
said image processing section is for performing energy subtraction processing using two radiation images;
said moving mechanism is set in said second mode by said switching mechanism; and
said moving mechanism moves said grid in the first direction when imaging a first radiation image, and moves said grid in the opposite direction to said first direction when imaging a second radiation image.

11. The radiation imaging apparatus according to claim 10, wherein;
said moving mechanism moves said grid in the first direction at a first speed when imaging said first radiation image; and
said moving mechanism moves said grid at a second speed which is different than said first speed in the opposite direction to said first direction when imaging said second radiation image.

12. The radiation imaging apparatus according to claim 11, wherein said second speed is faster than said first speed.

13. The radiation imaging apparatus according to claim 11, wherein said second speed is slower than said first speed.

14. The radiation imaging apparatus according to claim 10, wherein imagings are respectively performed with a timing in which the positional relationship between said grid and said radiation conversion panel is a same when taking the first radiation image and when taking the second radiation image.

15. The radiation imaging apparatus according to claim 14, wherein imagings are respectively performed with a timing in which a center position of said grid and a center position of said radiation conversion panel match when taking the first radiation image and when taking the second radiation image.

16. The radiation imaging apparatus according to claim 14, wherein imagings are respectively performed with a timing in which an amount of shift of said grid from a center position of said radiation conversion panel is a same when taking the first radiation image and when taking the second radiation image.

17. The radiation imaging apparatus according to claim 9, wherein:
said image processing section is for performing energy subtraction processing using two radiation images;
said moving mechanism is set in said first mode by said switching mechanism; and
said moving mechanism moves said grid in the first direction when taking the first and second radiation images.
